(19) United States
(12) Patent Application Publication
(10) Pub. No.: US 2002/0104502 A1
(43) Pub. Date: Aug. 8, 2002

(54) Air intake muffler and outboard engine assembly having the same

(76) Inventors: Masanori Tsubouchi, Wako-shi (JP); Tomonori Ikuma, Wako-shi (JP)

Correspondence Address: Adams & Wilks, 31st Floor, 50 Broadway, New York, NY, 10004, US

(21) Appl. No.: 10/068,430

(22) Filed: Feb. 6, 2002

(30) Foreign Application Priority Data
Feb. 7, 2001 (JP) 2001-030826
Feb. 8, 2001 (JP) 2001-031904

(51) Int. Cl. F02M 35/10

(52) U.S. Cl. 123/184.57

(57) ABSTRACT

A box-shaped air intake muffler wherein upper and lower separate dish-shaped two halves mated and joined to one another. One of the halves unitarily has an air intake connecting duct to be connected to an air intake passage of a throttle valve unit of an engine. Both of the two halves have concave portions unitarily formed therewith so as to protrude outward, respectively, with respective concave portions being mated with one another to form an outside air intake duct for introducing outside air.

### FIELD OF THE INVENTION

The present invention relates generally to an air intake muffler (silencer) for an engine and, more particularly, to an air intake muffler for a vertical multi-cylinder engine for use in an outboard engine assembly.

### BACKGROUND OF THE INVENTION

An air intake muffler (silencer) of this kind is disclosed in, for example, Japanese Patent Laid-Open Publication No. HEI-8-93433. The air intake muffler has an overall box shape which is composed of a flat base plate, a plurality of air horns mounted on the base plate so as to protrude toward the inside of the box, and a case covering the base plate. The base plate and the case are joined to one another in a unitary structure to form the box shape. The air horns form air intake connecting passages which communicate with a throttle of the engine. Since outermost surfaces of the air horns are flat, a difficulty is encountered in connecting a terminal end portion of the air intake passage or path of the throttle valve unit to the air horns and in sealing the joint portions, with a resultant difficulty in ensuring a sealing property in high precision.

Further, since the air horns are so arranged as to protrude in an internal space of the air intake muffler to allow the same to be connected to the air intake passage of the throttle valve unit in an easy and reliable manner, although it is thinkable to provide fitting-type joint portions to the outermost surfaces of the air horns, the base plate of the air intake muffler becomes complicated in structure causing intricate and troublesome manufacturing processes.

Furthermore, although there is a need for locating an outside air intake opening, in addition to the air intake connecting passage, in the air intake muffler and the prior art practice contemplates the provision of apertures in the box-shaped air intake muffler, the use of the apertures encounter a problem in view of an air intake efficiency. As a consequence, it is preferable for a cylindrical member to be incorporated in order to obtain a tube-length effect (wherein induction noise, generated by vibration of air caused during air sucking, is substantially determined by the dimension of the intake pipe), with a resultant increase in the number of component parts causing the need for providing a sealing structure between the cylindrical member and the air intake muffler, resulting in an additional increase in the number of component parts, a complicated structure and an increased cost.

In the outboard engine assembly, further, since the air intake muffler is mounted to one of areas in fore and aft directions of the vertical type engine with a vertical crankshaft, the outboard engine assembly involving the engine is largely sized in structure in fore and aft directions.

### SUMMARY OF THE INVENTION

It is therefore an object of the present invention to provide an air intake muffler which is unitarily formed with a cylindrical outside air intake opening having a cylindrical joint opening, to be connected to a throttle valve unit, and a tube-length effect without requiring additional component parts in manufacturing stages of a box-shaped muffler body.

According to a first aspect of the present invention, there is provided an air intake muffler for introducing outside air to feed the same to an air intake passage of a throttle valve unit of an engine, which muffler comprises a box body, an air intake connecting duct adapted to be connected to the air intake passage, and at least one outside air intake duct for introducing the outside air into the box body, wherein the box body includes two halves by one of which the air intake connecting duct is unitarily formed so as to protrude outwardly, and the outside air intake duct is formed by mating concave portions to one another which are unitarily formed with both of the two halves so as to protrude outwardly.

The box-shaped air intake muffler body is able to be unitarily formed with the air intake connecting duct, to be connected to the throttle valve unit, and the outside air intake duct without the need for additional component parts except for the upper and lower halves in stages of manufacture of the air intake muffler body by allowing dish-shaped two halves to be mated to and jointed to one another. As a consequence, manufacture can be easily performed without need for additional component parts, with a resultant decrease in the number of component parts while cutting costs.

Further, the body of the air intake muffler is formed into dish-shaped two halves, one of which is unitarily formed with the air intake connecting duct and the other one of which is unitarily formed with the concave portion which forms a remaining half of the outside air intake duct. Accordingly, during manufacture of the air intake muffler, merely jointing the halves to one another by means of adhesion or screw tightening, etc, enables the air intake muffler, having the air intake connecting duct and the outside air intake duct, to be easily manufactured.

Furthermore, since the air intake connecting duct and the outside air intake duct are unitarily formed with the body of the air intake muffler, there is no need for the muffler body, and the air intake connecting duct and the outside air intake duct to be sealed off.

The outside air intake duct of the air intake muffler includes, for example according to examples of the preferred embodiments, two components, with these two outside air intake duct components being formed in a V-shaped configuration so as to diverge rearwardly. Thus, the presence of two outside air intake ducts whereas a single air intake connecting duct to be connected to the throttle valve unit is provided improves air intake efficiency with favorable reduction in induction noises.

The two halves are composed of upper and lower half components, and the air intake connecting duct and the outside air intake duct are located in a horizontal direction. Thus, the presence of the air intake connecting duct and the outside air intake duct extending in the horizontal direction enables the height of the air intake muffler to be limited to a minimum value to allow, for example, the use of the air intake muffler for the outboard engine assembly for thereby making it possible to miniaturize the outboard engine assembly.

One of the two halves of the air intake muffler is formed with a retaining frame at a position wherein the air intake connecting duct is formed to allow a peripheral edge of a frame arrestor, which is composed of a mesh member, to be inserted in the retaining frame such that the frame arrestor is mounted in the retaining frame. During the course of mating and jointing the two halves to one another, it is possible for the air intake muffler to be easily manufactured under a condition wherein the mesh member, which forms the frame arrestor mounted to the retaining frame formed in one of the halves, is internally incorporated. The frame arrestor is mounted in the retaining frame in a plane perpendicular to an axis of the air intake connecting duct.

According to a second aspect of the present invention, there is provided an outboard engine assembly which comprises an engine, and an air intake muffler located above the engine and including an air intake connecting duct connected to an air intake passage of a throttle valve unit of the engine, and at least one outside air intake duct for introducing outside air.

In the thus arranged outboard engine assembly, presence of the air intake muffler located above the engine allows an upper surface of the engine to be effectively utilized. According to the preferred embodiments, for example, the engine comprises a V-type multi-cylinder vertical engine wherein the air intake muffler having a substantially flat bottom wall is placed above a drive pulley, driven by a crankshaft of the engine, and a belt engaging the drive pulley. That is, since the air intake muffler is located above the belt, etc. which is positioned above the engine, the belt and the engine are opened at their side areas to provide an improved heat dissipating property of the belt and the engine.

### BRIEF DESCRIPTION OF THE DRAWINGS

Certain preferred embodiments of the present invention will be described in detail below, by way of example only, with reference to the accompanying drawings, in which:

FIG. 1 is a perspective view of an air intake muffler according to a first embodiment of the present invention;

FIG. 2 is an exploded perspective view of the air intake muffler shown in FIG. 1;

FIG. 3 is a plan view of a lower half of the air intake muffler shown in FIG. 2;

FIG. 4 is a plan view of the air intake muffler shown in FIG. 1;

FIG. 5 is a front view of the air intake muffler shown in FIG. 1;

FIG. 6 is a cross sectional view taken on line 6-6 of FIG. 4;

FIG. 7 is an enlarged cross sectional view illustrating a retaining structure of a mesh member shown in FIG. 6 in detail;

FIG. 8 is a cross sectional view taken long a line 7-7 of FIG. 7;

FIG. 9 is a plan view illustrating a modified form of the air intake muffler;

FIG. 10 is a front view of the air intake muffler shown in FIG. 9;

FIG. 11 is a front view illustrating another example of the mesh member shown in FIG. 9;

FIG. 12 is a cross sectional view taken on line 12-12 of FIG. 11;

FIG. 13 is a side view of an outboard engine assembly;

FIG. 14 is an enlarged view of the outboard engine assembly shown in FIG. 13 with an upper part thereof cut away;

FIG. 15 is a plan view of an engine with an upper part of an engine cover of the outboard engine assembly cut away;

FIG. 16 illustrates an upper area of the engine with the air intake muffler and an intake system of FIG. 15 removed;

FIG. 17 is an enlarged longitudinal cross sectional view illustrating a relationship among the air intake muffler, a throttle valve unit and the engine;

FIG. 18 is a rear view of an essential part of the engine involving an intake manifold;

FIG. 19 is a perspective view of an air intake muffler according to a second embodiment of the present invention; and

FIG. 20 is a front view of the air intake muffler shown in FIG. 19.

### DETAILED DESCRIPTION OF THE EMBODIMENTS

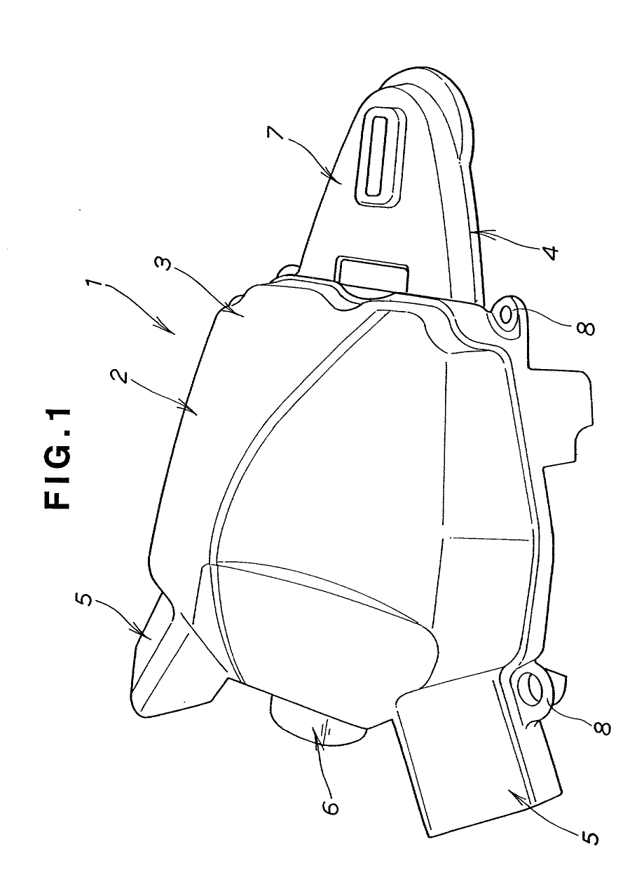

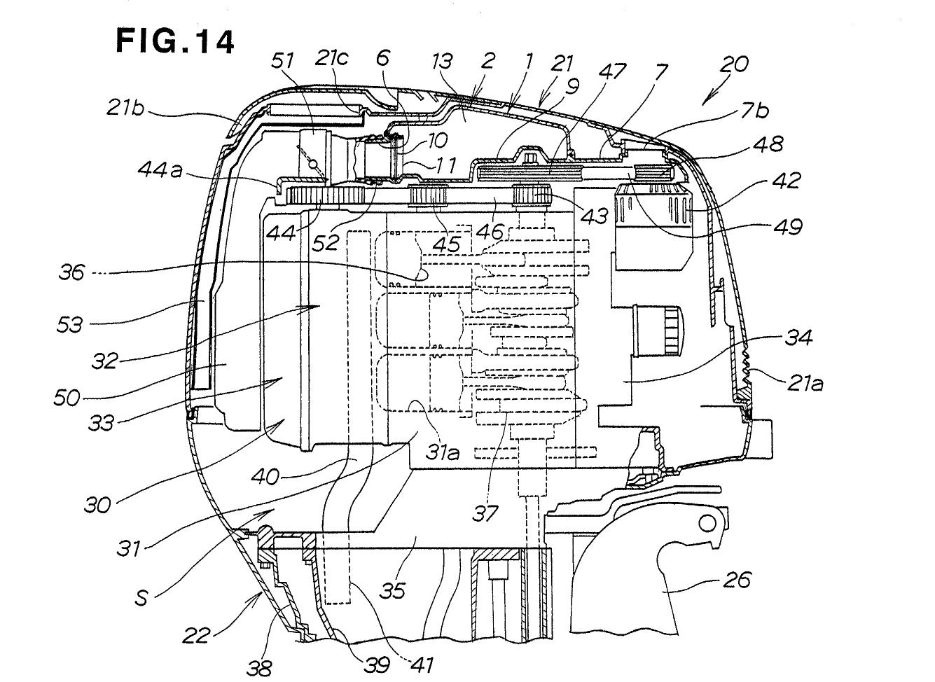

An air intake muffler 1 shown in FIG. 1 is used as an air intake muffler of an engine of an outboard engine assembly as shown in FIG. 14 and is located above a V-type multi-cylinder vertical engine with its crankshaft extending in a vertical direction. A body 2 of the air intake muffler 1 has a flat thin type box-shaped configuration and includes upper and lower halves 3, 4.

The muffler body 2 has two outside air intake ducts 5, 5 for introducing outside air, and an air intake connecting duct 6 for delivering outside air, which is introduced, into the engine. The two outside air intake ducts 5, 5 extend rearward from both rear portions of the body 2 in a V-shape spreading direction. The air intake connecting duct 6 is formed at an intermediate portion of a lengthwise rear area of the body 2 so as to open rearwardly (in a direction opposed to a direction in which the outboard engine assembly is propelled).

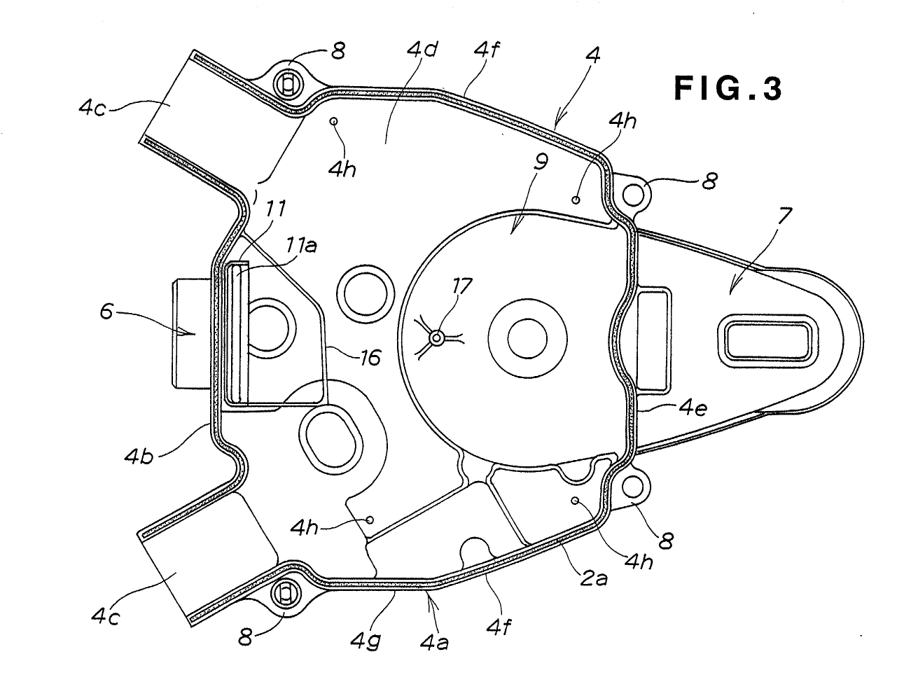

The lower half 4 has a cover section 7 which protrudes forward from a front area of the upper half 3. The lower half 4 has four mount stays 8 as shown in FIG. 3. Each of the stays 8 has a mount bore.

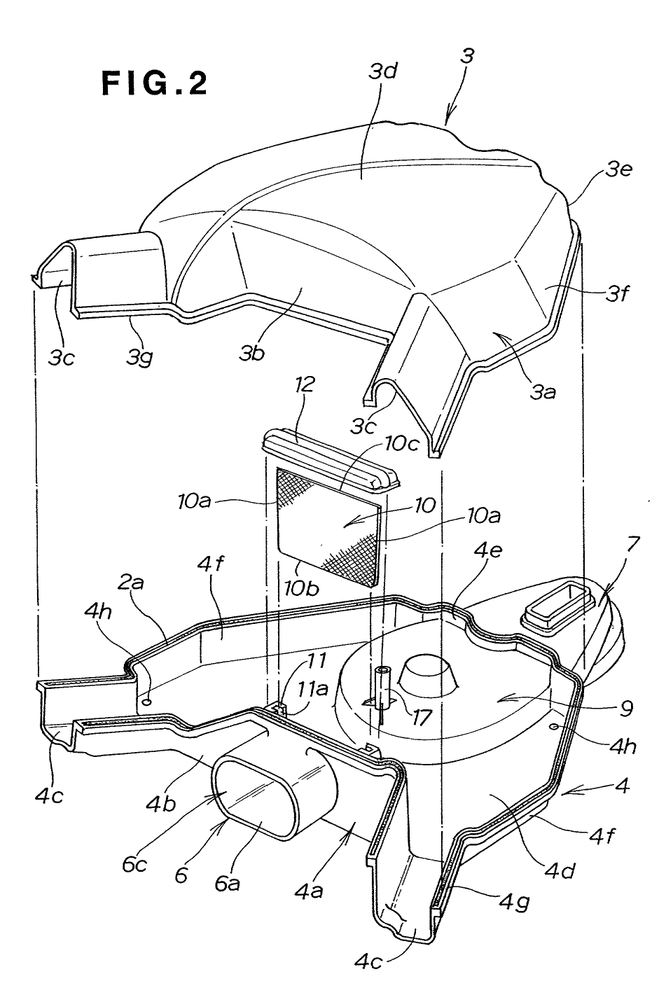

FIG. 2 shows the intake air muffler in an exploded state of the upper and lower halves 3, 4.

The lower half 4 has an outer periphery surrounded with an upright wall 4a to form a dish-shaped configuration. An intermediate area of a rear wall 4b which forms a part of the upright wall 4a is formed with the air intake connecting duct 6 which has a cylindrical structure formed in an oblong configuration with a lateral longitudinal axis lying in a horizontal plane. An intake air passage of the air intake connecting duct 6 communicates with the inside of the lower half 4. The air intake connecting duct 6 has an upstream opening 6b formed in the rear wall 4b, and a downstream opening 6c whose rear distal end is opened.

Further, the rear wall 4b of the lower half 4 is formed with two gutter-shaped concave portions 4c, 4c. The concave portions 4c, 4c form gutter portions. The concave portions 4c, 4c are formed at boundary areas between both sides of the rear wall 4b and right and left side walls 4f, 4f to allow the inside and the outside of the dish-shaped lower half 4 to communicates with one another.

A front half of a bottom portion 4d of the lower half 4 is formed with an embossed portion 9 which is embossed upward in a semicircular configuration, as viewed in a plane, with a front area of the embossed portion 9 facing a laterally extending front wall 4e which is contiguous with the right and left side walls 4f, 4f.

The upper half 3 has a symmetrical shape with the lower half 4 to have a suspended wall 3a which suspends from a periphery of a ceiling portion 3d to surround the same and is formed in a reversed dish-shaped configuration. Both sides of a rear wall 3b of the suspended wall 3a are formed with concave portions 3c, 3c composed of downwardly facing gutter-shaped portions, which are reversed in structure, so as to meet with the associated concave portions 4c, 4c of the lower half 4. The concave portions 3c, 3c are formed at boundary areas between right and left ends of the rear wall 3b and right and left ends of the side walls 3f so as to protrude rearward. The bottom portion 4d of the lower half 4 is formed with four drain ports 4h as shown in the drawing. The drain ports 4h serve to drain water entering with outside air through the air intake connecting ducts 5, 5. Further, a water entry block plate 16 is formed at an upstream side of the air intake connecting duct 6 to preclude water, which has entered from the outside air intake ducts 5, 5, from being delivered to the air intake connecting duct 6. The water entry block plate 16 functions as a dam.

The upper and lower halves 3, 4 are mated to and joined to one another to form a unitary structure. For example, a lower edge portion 3g of the suspended wall 3a of the upper half 3 is brought into abutting engagement with an upper edge portion 4g of the upright wall 4a of the lower half 4 via a seal member 2a and is adhered thereto by an adhesive. In place of the adhesive, the mated portions may be deposited to one another by vibrating deposition or may be fixed to one another by bolts if desired. The lower half 4 has a strut 17. The presence of the strut 17 allows the upper and lower halves 3, 4 to resist the pressure exerted in a vertical direction and has a structure which prevents deformation while reducing vibrations and noises caused during air intake. Mating and jointing the upper and lower halves 3, 4 to one another allows the concave portions 3c, 3c formed in the upper half 3 and the concave portions 4c, 4c formed in the lower half 4 to be overlapped with one another, forming the air intake ducts 5, 5 as shown in FIG. 1.

When mating and jointing the upper and lower halves 3, 4 with each another, a mesh member 10 serving as a frame arrestor is interposed.

As shown in FIGS. 2 and 3, a retaining frame 11, which has a concave type structure, as viewed in a plane, composed of three frame components such as lower frame component and both sidewise frame components, is located at an area inside the rear wall 4b of the lower half 4 and upstream of the air intake connecting duct 5. A continuous engaging recess 11a is formed inside the three frame components of the retaining frame 11. The mesh member 10 is formed of metal, for example, stainless steel wires, and has a rectangular plate configuration with a lateral longitudinal axis lying in the horizontal plane in the illustrated preferred embodiment. The mesh member 10 is inserted downward from the above in the engaging recess 11a of the retaining frame 11 along with the right and left side edge portions 10a, 10a and a lower edge portion 10b. And, an oblong cap-shaped press member 12 is put on an upper edge 10c of the mesh member 10 to fixedly secure the mesh member 10 to the retaining frame 11 in place.

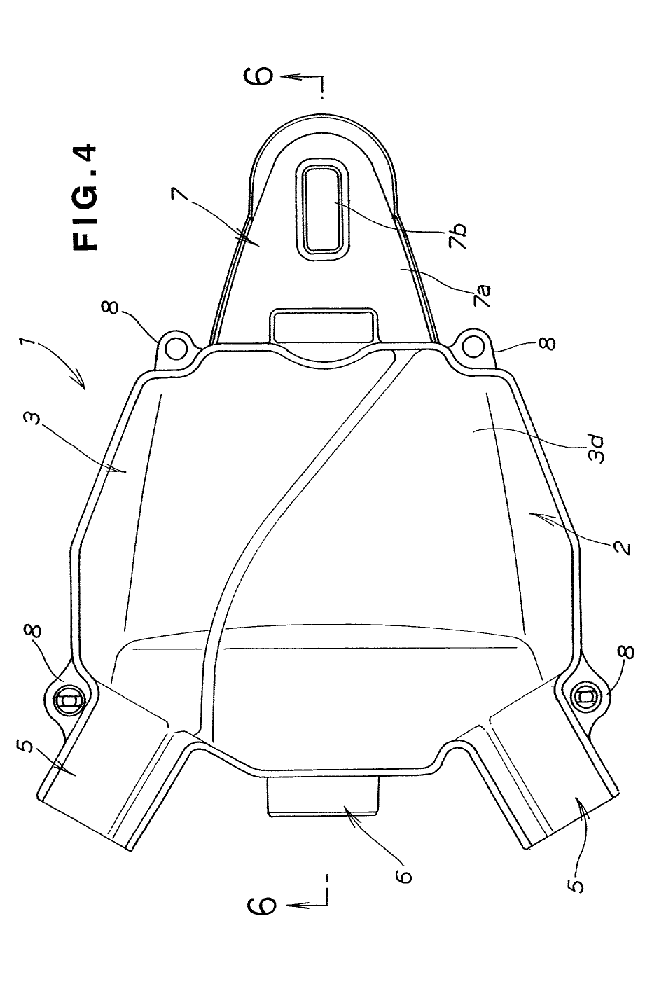

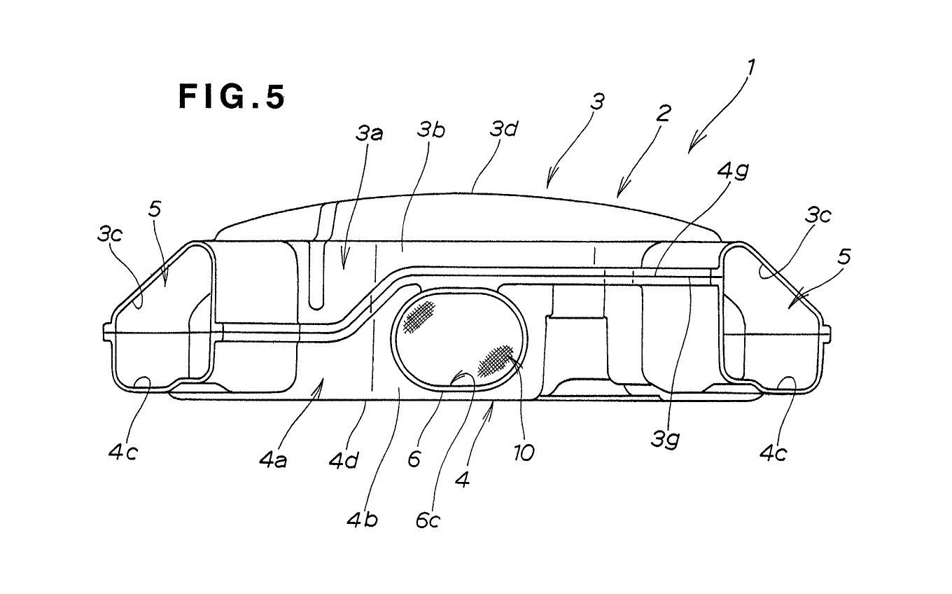

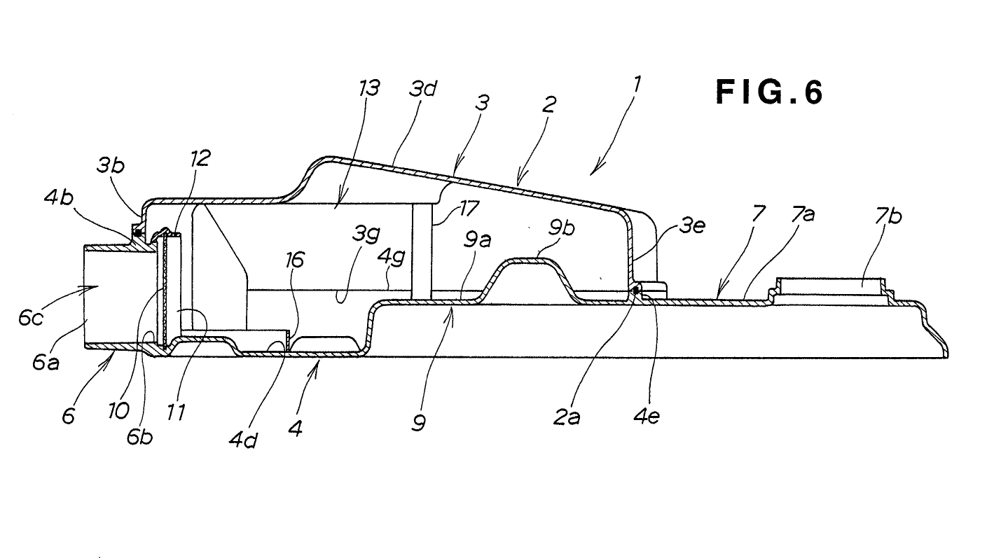

As shown in FIGS. 4 to 6, a front half portion of an intermediate section, in width wise direction, of the bottom portion of the lower half of the muffler body 2 is formed with the embossed portion 9 shaped in a semicircular configuration, as viewed in a plane, which upwardly extends from the bottom portion 4d as previously described above. The front portion of the lower half 4 has a cover portion 7 which extends forward in a unitary structure.

The ceiling 9a of the embossed portion 9 and a ceiling 7a of the cover portion 7 are contiguous in the same plane. A central portion of the ceiling 9a of the embossed portion 9 is formed with a protruding portion 9b which extends upward. A front portion of the ceiling 7a of the cover portion 7 is formed with a ventilation opening 7b.

When mounting the air intake muffler 1 to the upper area of the engine, the embossed portion 9 and the cover portion 7 serve to avoid interference with the belt with respect to a height thereof. Thus, a need for miniaturization of an overall structure of an engine room is satisfied. Further, the presence of the air intake muffler 1 located above the belt allows a belt cover to be dispensed with.

The muffler body 2 internally defines an air intake muffler chamber 13. The air intake muffler chamber 13 communicates with the air intake passage of a throttle valve unit via the air intake connecting duct 6 and also communicates with the outside via the outside air intake ducts 5, 5.

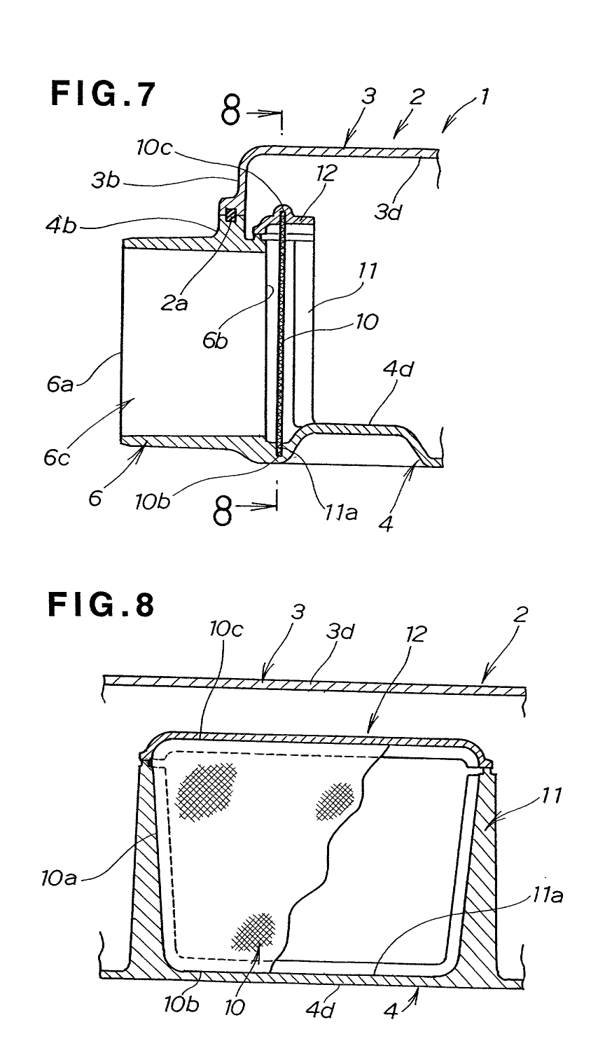

Referring now to FIGS. 7 and 8 which illustrate the mount structure of the mesh member 10 in detail, the retaining fame 11 of the mesh member 10 is located in the vicinity of the upstream opening 6b so as to surround the right and left and lower areas of the upstream opening 6b formed at the rear wall 4b of the lower half 4, with the upper area being open to form the concave configuration as viewed in FIG. 7. The engaging recess 11a, through which the mesh member 10 is inserted, is formed inside the retaining frame 11. The both side frame components of the retaining frame 11 of the concave configuration are slanted so as to spread in an upward direction. Thus, if the spread area of the upper side is wider than that of the bottom side, it becomes easy for the mesh member 10 to be inserted in the retaining frame 11.

After the mesh member 10 is inserted such that the right and left side edge portions 10a, 10a of the mesh member 10 engage the engaging recess 11a of the retaining frame 11, the press member 12 is put on the upper edge portion 10c of the mesh member 10 to retain the mesh member 10 in place. The right and left edge portions 10a, 10b of the mesh member 10 are shaped in a downwardly narrowed profile so as to cope with the shape of the retaining frame 11. This results in a protection of looseness, along with the inclination of the retaining frame 11, that would occur after the mesh member 10 has been mounted.

Thus, the mesh member 10, which forms the frame arrestor, is assembled in the course of overlapping the upper and lower halves 3, 4 to one another.

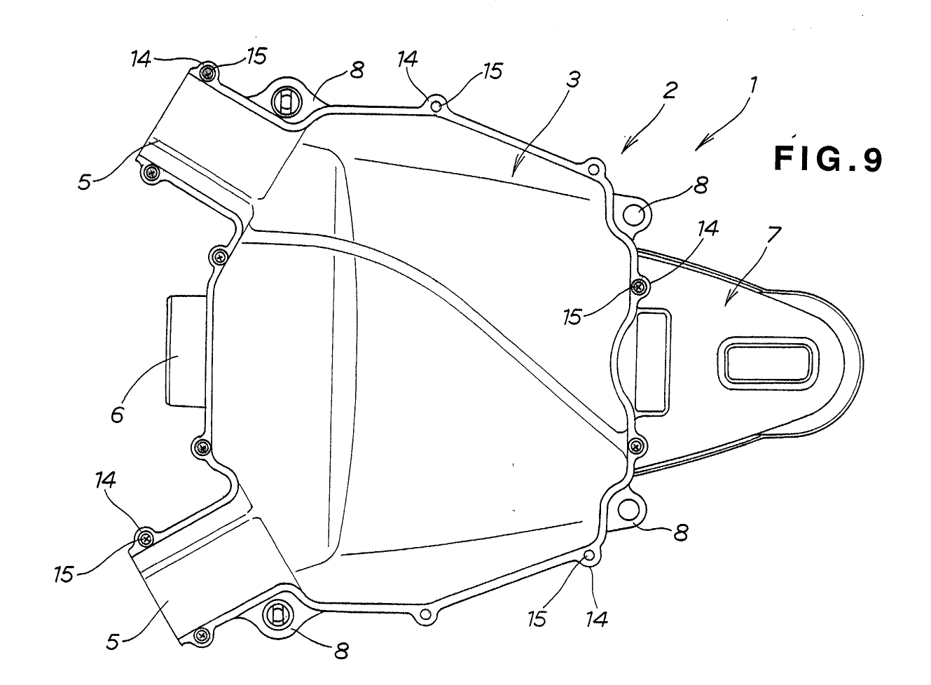

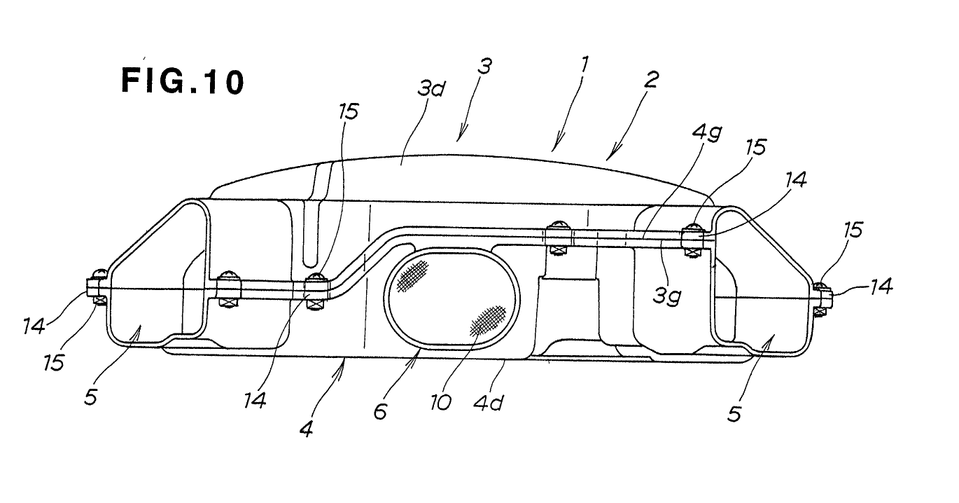

FIGS. 9 and 10 show a modified form of the air intake muffler of the first preferred embodiment according to the present invention.

In the modified form, when jointing the upper and lower halves 3, 4 to one another to form the unitary structure, the edge portions 3g, 4g, which form the joint portions of the upper and lower halves 3, 4, are formed at pluralities of locations formed with boss portions 14 through which screws 15 are inserted and are tightened to allow the edge portion 3g of the upper half 3 and the edge portion 4g of the lower half 4 to be joined to one another. Thus, in addition to the adhesion and deposition technologies, or in place thereof, the upper and lower halves 3, 4 may be joined together by screws into the unitary structure. During such operation, the presence of the screws 15 arranged to be tightened in the same direction provides an improved workability and the presence of an arbitrary one of the screws 15 arranged to be tightened in a direction different from those of the other screws enables an assembling sequence to be standardized.

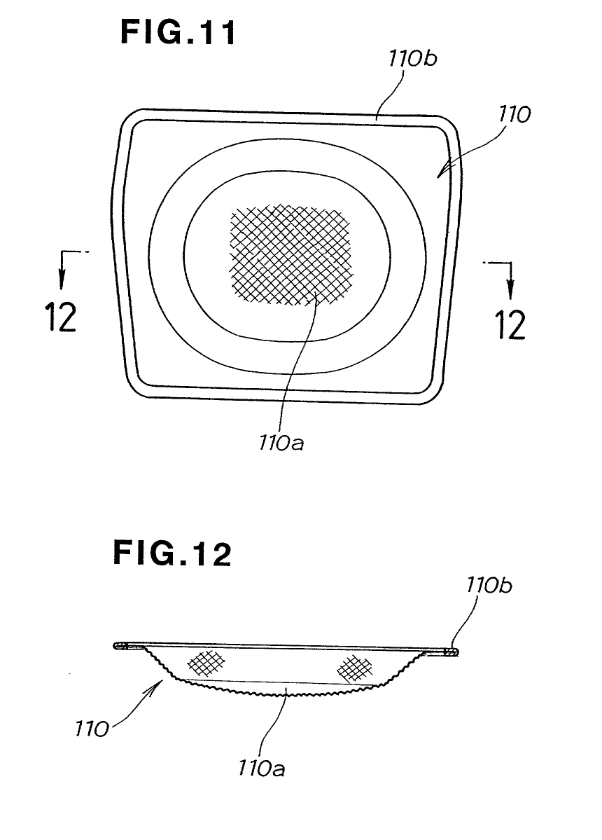

FIGS. 11 and 12 show a mesh member of another preferred embodiment. The mesh member 110 of this preferred embodiment includes a mesh body 110a which is made of stainless steel wires which are woven to expand at a central area. A peripheral portion of the mesh body 110a is retained with a frame member 110b. The mesh member 110 of this preferred embodiment also has a shape wherein right and left side edge portions are downwardly narrowed as that of the preferred embodiment described above, thereby precluding looseness, along with the inclination of the retaining frame 11, that would occur after the mesh member 110 has been mounted.

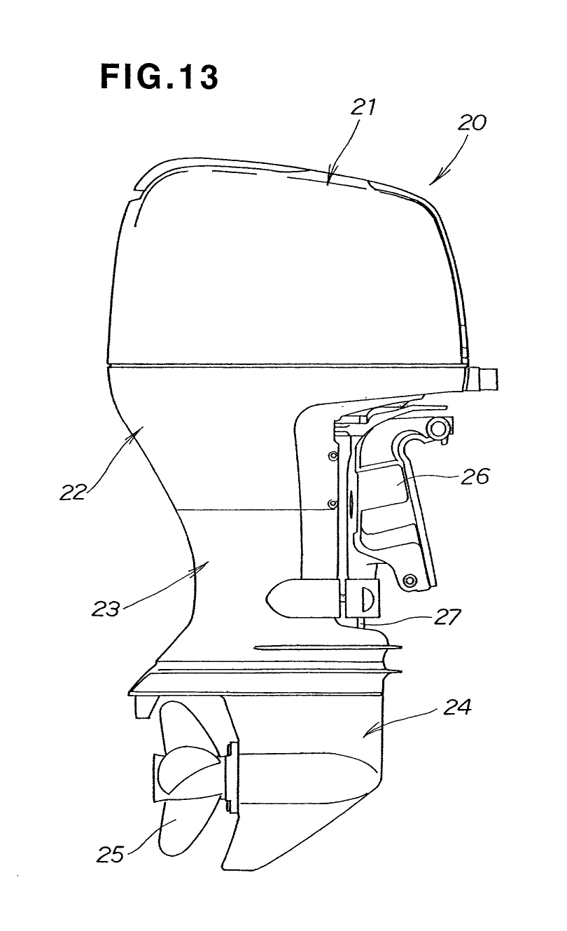

Now, an outboard engine assembly, which is mounted with the air intake muffler according to the present invention, is described below with reference to FIGS. 13 to 18. The outboard engine assembly shown in the drawings includes a vertical engine of the V-type multi-cylinder.

In FIG. 13, the outboard engine assembly 20 includes an upper engine cover 21, an under cover 22 located below the engine cover 21, an extension case 23 located below the under cover 22, and a gear case 24 located below the extension case 23.

A screw 25 is mounted at a rear end of the gear case 24. At a front portion between the under cover 22 and the extension case 23, a stern bracket 26 is mounted to be rotatable about a swivel axis 27.

As shown in FIG. 14, the engine cover 21 covers the engine 30 and accessories and defines an engine room S.

The engine 30 includes a cylinder block 31, a cylinder head 32, a cylinder head cover 33, a crankcase 34, a piston 36 and a crankshaft 37, and is mounted on a mount case 35.

The cylinder block 31 has a plurality of cylinders 31a which are arrayed in a vertical direction. The cylinder head 32 is located rearward of the cylinder block 31. The cylinder head cover 33 is located rearward of the cylinder head 32. The crankcase 34 is located at a front of the cylinder block 31.

The mount case 35 is supported with the extension case 38 which is covered with the under cover 22. An oil pan 39 is located inside the extension case 38.

An exhaust port of the cylinder head 32 is connected to an exhaust manifold 40. The exhaust manifold 40 is connected to an exhaust pipe 41. The exhaust pipe 41 extends downward and expels exhaust gases downward of the extension case 23 shown in FIG. 13.

An alternating current electric power generator (ACG) 42 is mounted at an upper area of the front portion of the crankcase 42. A pulley 43, which is driven with the crankshaft 37, and a drive pulley 47 for driving the electric power generator are located at an upper area of the cylinder block 31. A camshaft drive pulley 44 is located at the upper area of the cylinder head 32. The drive pulley 43 and the camshaft drive pulley 44 are drivably coupled to one another via an intermediate tension pulley 45 for driving the camshaft. An upper side of the camshaft drive pulley 44 is covered with a pulley cover 44a. The air intake muffler 1 according to the present invention is located above the tension pulley 45, the drive pulley 43, the drive pulley for the electric power generator and the electric power generator pulley 48.

The timing belt 46 is located so as to have a narrow width (in a lateral width) in a right and left direction in the engine room S by means of the plurality of tension pulleys 45, 45, 55, thereby ensuring a space between the both sides of the lower area of the air intake muffler 1 and the upper area of the engine 30. Accordingly, air is discharged from the side areas between the upper area of the engine and the air intake muffler, contributing to a heat dissipating property of the belt/pulley mechanism. Further, the presence of the intake air muffler allows covers for the pulleys 43, 45, 47 except for the camshaft drive pulley 44 to be dispensed with.

The crankshaft 37 is mounted with an electric power generator drive pulley 47 of a larger diameter than the drive pulley 43. A timing belt 49 extends between the electric power generator drive pulley 47 and an electric power generator driven pulley 48 for driving the electric power generator 42.

An intake manifold 50 is mounted at a rear area of the cylinder head cover 33. A throttle valve unit 51 is mounted at an upper area of the intake manifold such that an air intake passage has an upstream portion orientated forward.

The air intake muffler 1 is located above the cylinder block 31 and the crankcase 34. The body 2 of the air intake muffler 1 is mounted to the engine side by means of the plurality of mount stays 8. The electric power generator drive pulley 47 of the larger diameter is located below the embossed portion 9 formed in the bottom portion of the body 2 of the air intake muffler 1. The driven pulley 48 of the electric power generator 42 is located below the ventilation opening 7b. The embossed portion 9 and the cover portion 7 form a cover member for the electric power generator drive pulley 47 and the driven pulley 48.

The air intake connecting duct 6 formed at the rear area of the box-shaped air intake muffler 2 is connected to the throttle body which forms the air intake passage of the throttle valve unit 51.

Connection between the air intake passage of the throttle unit 51 and the air intake connecting duct 6 is performed by means of a grommet 52 by compelling a cylindrical portion of the air intake connecting duct 6 to be mated with the air intake passage. Thus, the connecting portion is easily and reliably sealed.

A front portion of the engine cover 21 is formed with a coolant air intake port 21a. An upper and rear portion of the engine cover 21 is formed with an outside air intake port 21b to allow an internal intake opening 21c to introduce outside air through a duct 53 into the engine room S defined with the engine cover 21.

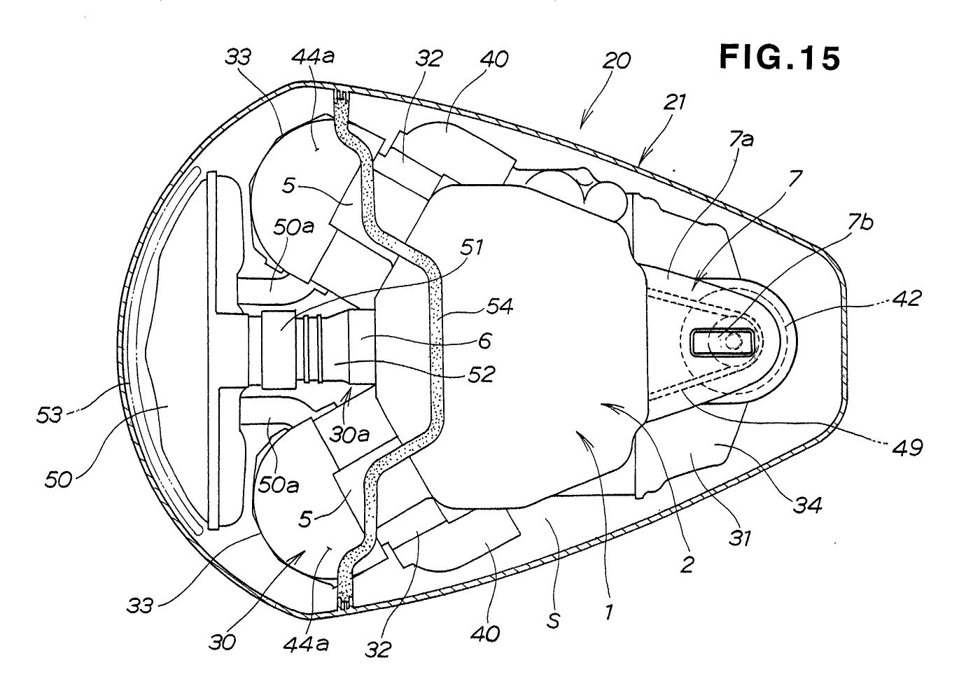

The engine 30 of the presently filed preferred embodiment shown in FIG. 14 has three cylinders 31a arrayed in a vertical direction, with the engine 30 being arranged in a V-type configuration, as viewed in a plane in FIG. 15, to form the four-stroke V-type six-cylinder vertical engine.

As shown in FIG. 15, a V-bank 30a of the cylinder block 31 is spread rearward. The air intake connecting duct 6 of the air intake muffler 1 is located inside the V-bank 30a. Also, the throttle valve unit 51 is located inside the V-bank 30a. The intake manifold 50 is located rearward of the spreading area of the V-bank 30a. An intake pipe 50a of each cylinder head 32 is located inside the V-bank 30a.

In the drawings, reference numeral 54 designates a seal member which partitions off the engine room S defined with the engine cover 21 to preclude heat generated by the cylinder heads 32, 32 from being transferred toward the electric power generator 42.

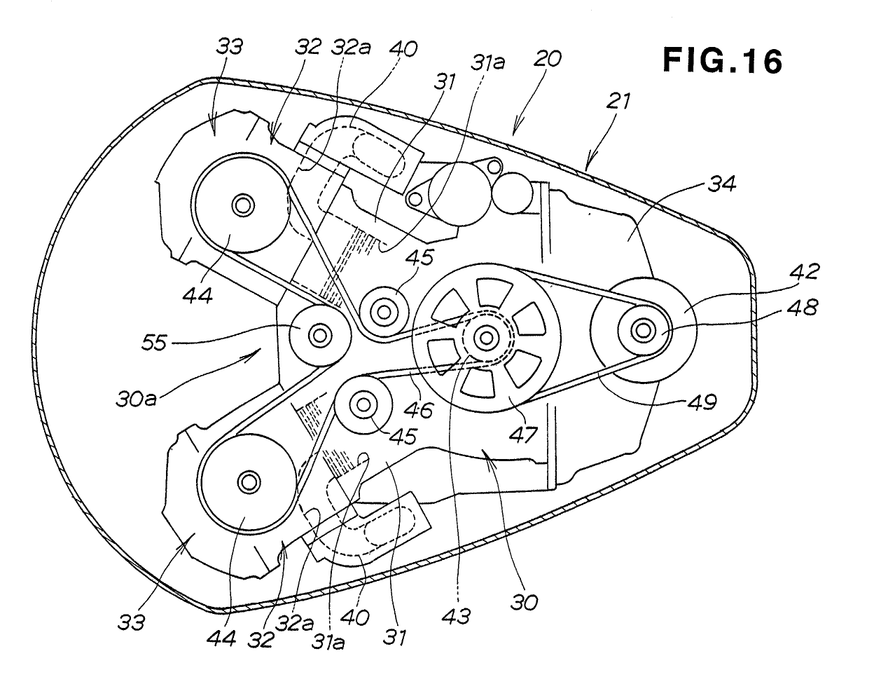

The exhaust manifold 40, which is connected to the exhaust ports 32a, 32a of the cylinder heads 32, 32 as shown in FIG. 16, extends downward in the engine room S as shown in FIG. 14 and is connected to the exhaust pipe 41. The exhaust pipe 41 is orientated downward and extends toward an area below the under cover 22 while passing through the under cover 22 and the extension case 23 to expel exhaust gases.

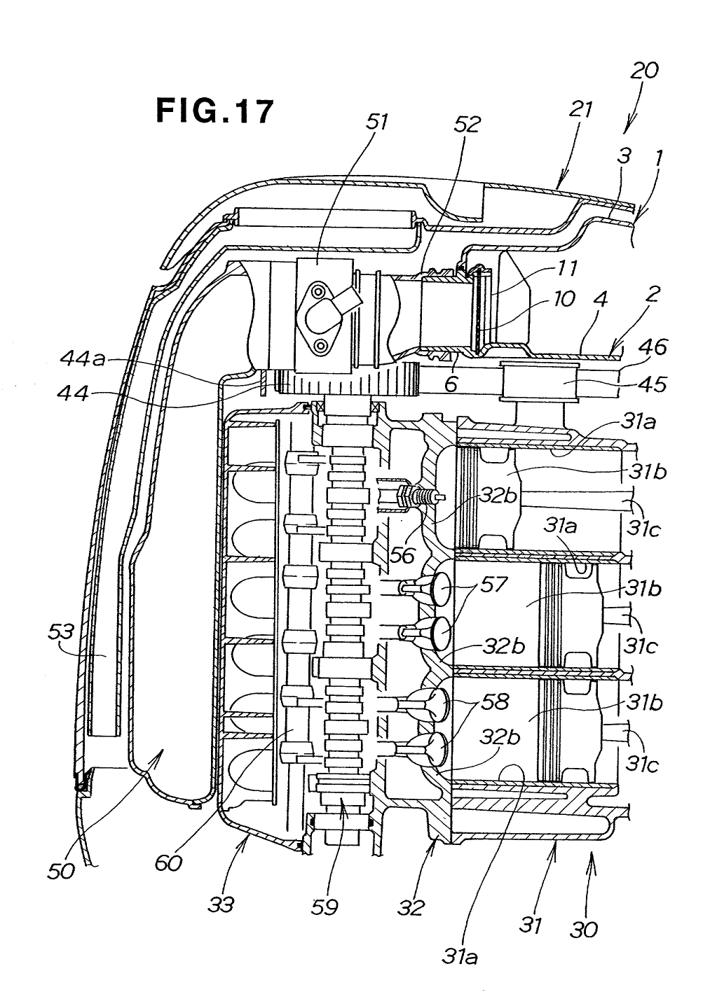

As shown in FIG. 17, respective cylinders 31a arrayed in three rows in a vertical direction laterally accommodates therein pistons 31b, respectively. Transverse con-rods 31c are connected to the crankshaft 37.

The cylinders 31a have respective combustion chambers 32b. Each of the combustion chambers 32b is mounted with an ignition plug 56, two intake valves 57 and two exhaust valves 58.

The camshafts 59 are positioned rearward of the respective cylinder heads 32. The camshafts 59 are driven with the camshaft drive pulleys 44, respectively. A rocker arm shaft 60 is located at right and left sides of the camshafts 59 for supporting valve rocker arms for opening and closing the intake and exhaust ports 57, 58. The cylinder head cover 33 covers the camshaft 59 and the rocker arm shaft 60.

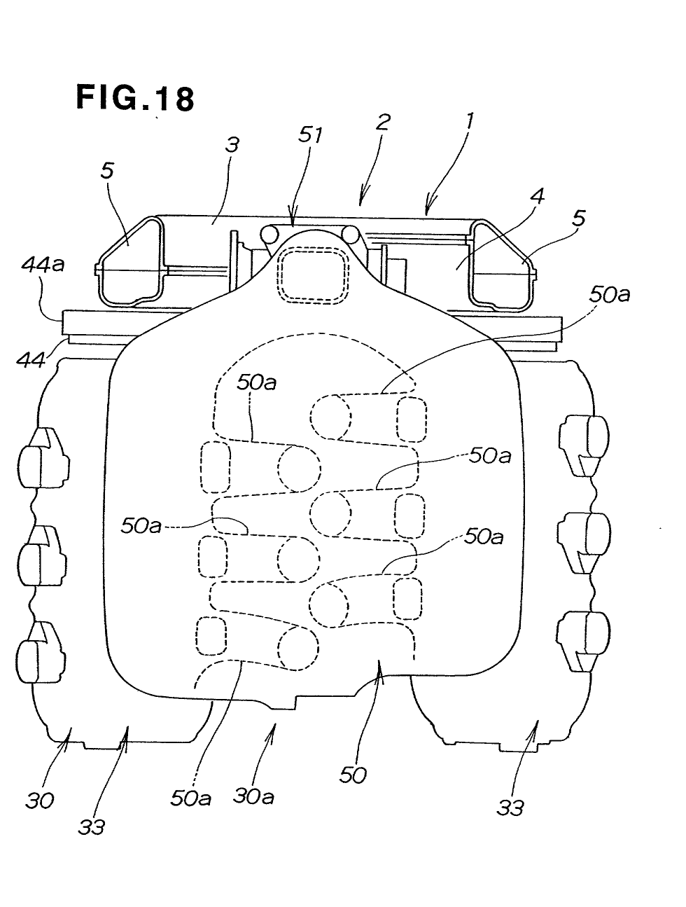

As shown in FIG. 18, the intake manifold 50 has a large volume and is positioned at the area rearward of the V-bank 30a which expands rearward of the engine 30.

The intake manifold 50 is connected to the intake valves 57 of the respective cylinders 30a of the engine 30 via the right and left two rows each with three in the vertical direction, i.e. the sum of six exhaust pipes 50a. The intake manifold 50 is connected at its upstream to the throttle valve unit 51. The throttle valve unit 51 is connected to the air intake connecting duct 6 of the air intake muffler 1 via the grommet as previously noted. The air intake connecting duct 6 is mounted with the mesh member 11 which forms the frame arrestor as described above.

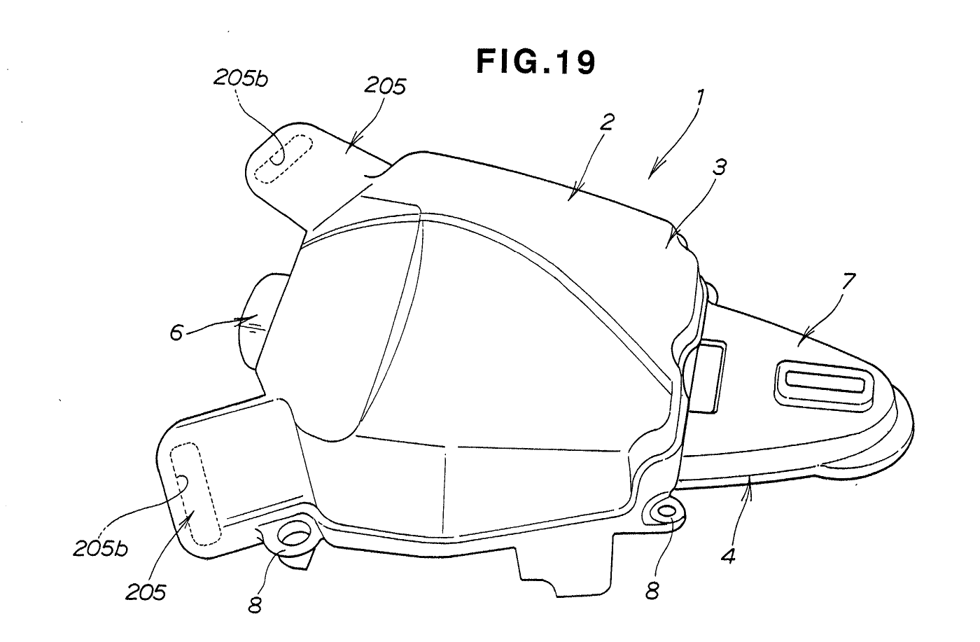

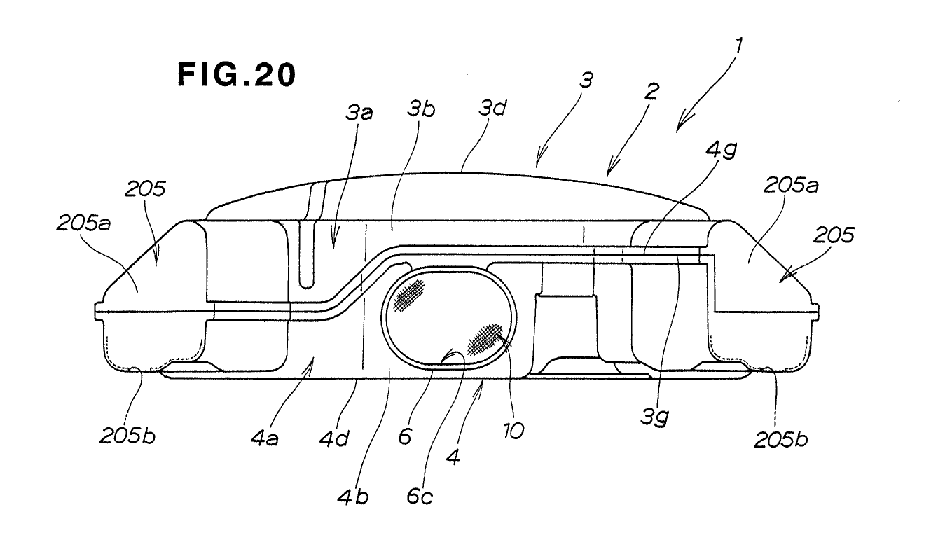

FIGS. 19 and 20 show the air intake muffler of a second preferred embodiment according to the present invention, with like parts bearing the same reference numerals as those of the first preferred embodiment to omit a description of the same.

As shown in FIG. 20, rear end walls 205a, 205a of outside air intake ducts 205, 205 are closed. The outside air intake ports 205b, 205b are formed to open downward at positions in the vicinities of rear distal ends of the outside air intake ducts 205, 205.

According to the present invention, as described in relation to the second preferred embodiment, the outside air intake ports 205b, 205b may be opened downwardly, sidewardly or upwardly, though not shown.

The present disclosure relates to the subject matters of Japanese Patent Application No. 2001-031904, filed Feb. 8, 2001, and Japanese Patent Application No. 2001-030826, filed Feb. 7, 2001, the disclosures of which are expressly incorporated herein by reference in their entireties.

What is claimed is:

1. An air intake muffler for introducing outside air to be fed to an air intake passage of a throttle valve unit of an engine, comprising:
a box body;
an air intake connecting duct designed to be connected to said air intake passage; and
at least one outside air intake duct for introducing outside air into said box body,
wherein said box body includes two halves by one of which said air intake connecting duct is unitarily formed so as to protrude outwardly, and said outside air intake duct is formed by mating concave portions to one another which are unitarily formed with both of said two halves so as to protrude outwardly.

2. An air intake muffler according to claim 1, wherein said outside air intake duct includes two air intake ducts which diverge into a V-shaped configuration.

3. An air intake muffler according to claim 1, wherein said two halves comprise upper and lower halves, and said air intake connecting duct and said outside air intake duct are arranged horizontally .

4. An air intake muffler according to claim 1, wherein one of said two halves is formed with a retaining frame at a position wherein said air intake connecting duct is formed to allow a peripheral edge of a frame arrestor, which is composed of a mesh member, to be inserted in the retaining frame such that said frame arrestor is mounted in said retaining frame.

5. An air intake muffler according to claim 4, wherein said frame arrestor is mounted in said retaining frame in a plane perpendicular to an axis of said air intake connecting duct.

6. An outboard engine assembly comprising:
an engine; and
an air intake muffler located above said engine and including an air intake connecting duct connected to an air intake passage of a throttle valve unit of the engine, and at least one outside air intake duct for introducing outside air.

7. An outboard engine assembly according to claim 6, wherein said engine comprises a V-type multi-cylinder vertical engine having a crankshaft for driving a drive pulley from which a belt extends, and said air intake muffler is located above said drive pulley and said belt.
